(19) United States
(12) Patent Application Publication
(10) Pub. No.: US 2022/0335394 A1
(43) Pub. Date: Oct. 20, 2022

(54) INFORMATION PROCESSING METHOD AND NON-TRANSITORY COMPUTER-READABLE STORAGE MEDIUM

(71) Applicant: Artrigger Inc., Tokyo (JP)

(72) Inventors: Madoka SAKAITANI, Tokyo (JP); Kenichi MOGI, Tokyo (JP)

(21) Appl. No.: 17/664,036

(22) Filed: May 18, 2022

Related U.S. Application Data
(63) Continuation of application No. PCT/JP2020/041080, filed on Nov. 2, 2020.

(30) Foreign Application Priority Data
Nov. 27, 2019 (JP) 2019-214426

(51) Int. Cl. G06Q 20/06; G06Q 50/18; G06Q 20/38; H04L 9/30; H04L 9/32

(52) U.S. Cl. CPC G06Q 20/06; G06Q 50/18; G06Q 20/3829; G06Q 20/3825; H04L 9/30; H04L 9/3247; G06Q 2220/00

(57) ABSTRACT

An acquisition part acquires a per-unit license fee for use of the content from the blockchain and a public key issued by an execution management system used by the licensee, from a blockchain in which a contract function is implemented to realize a license agreement. The acquisition part acquires information including a number of pieces of content used by the licensee from the execution management system used by the licensee. A verification part verifies validity of a signature of content usage information. A calculation part calculates a royalty token corresponding to an amount obtained by multiplying the number of pieces of content used by the per-unit license fee, on condition that the signature is valid. A registration part registers the number of pieces of content used and the royalty token in the blockchain.

### CROSS-REFERENCE TO RELATED APPLICATIONS

The present application is a continuation application of International Application number PCT/JP2020/41080, filed on Nov. 2, 2020, which claims priority under 35 U.S.C § 119(a) to Japanese Patent Application No. 2019-214426, filed on Nov. 27, 2019. The contents of the above applications are incorporated herein by reference in their entirety.

### BACKGROUND OF THE INVENTION

The present disclosure relates to an information processing method and a non-transitory computer-readable storage medium, and more particularly, to a technique for managing payment of a license fee using a blockchain.

In recent years, manufacture and sales of industrial products have increasingly been managed by a computer-based management system. For example, Japanese Unexamined Patent Application Publication No. 2018-73137 discloses a technique for managing manufacture and sales of medical instruments.

Those who manufacture and sell products often do so under license from a right holder who has a right to manufacture and sell the product. Generally, in such cases, a person who manufactures and sells the product pays the right holder a license fee on the basis of the number of products manufactured or sold.

The above system for managing the manufacture and sales of the products is a system for manufacturers that is used to manage the number of orders, delivery deadlines, and the like of the products, and is not used by right holders. Thus, payment of the license fee is calculated on the basis of the number of products manufactured and sold as reported to the right holder by the person who manufactures and sells the product. There is a possibility that those who manufacture and sell products will make false reports to a right holder, and there is a need for greater transparency in the number of products manufactured and sold under license.

### BRIEF SUMMARY OF THE INVENTION

The present disclosure focuses on this point, and an object thereof is to provide a technique for improving the transparency of the number of products manufactured and sold under license.

A first aspect of the present disclosure provides an information processing method executed by a processor of a computer executing a license fee payment contract function implemented in a blockchain in which a contract function is implemented to realize a license agreement for use of content agreed upon between a licensor and a licensee. The information processing method includes the step of acquiring a per-unit license fee for use of the content from the blockchain, acquiring a public key issued by an execution management system used by the licensee, from the blockchain, acquiring content usage information that is information including a number of pieces of content used by the licensee and that is information signed using a private key corresponding to the public key, from the execution management system, verifying validity of a signature of the content usage information using the public key, calculating a royalty token corresponding to an amount obtained by multiplying the number of pieces of content used by the per-unit license fee, on condition that the signature is valid, and registering the number of pieces of content used and the royalty token in the blockchain.

A second aspect of the present disclosure provides a non-transitory computer-readable storage medium storing a program for causing a computer to realize a license fee payment contract function implemented in a blockchain in which a contract function is implemented to realize a license agreement for use of a content agreed upon between a licensor and a licensee. The license fee payment contract function includes acquiring a per-unit license fee for use of the content from the blockchain, acquiring a public key issued by an execution management system used by the licensor, from the blockchain, acquiring content usage information that is information including a number of pieces of content used by the licensee and that is information signed using a private key corresponding to the public key, from the execution management system, verifying validity of a signature of the content usage information using the public key, calculating a royalty token corresponding to an amount obtained by multiplying the number of pieces of content used by the per-unit license fee on condition that the signature is valid, and registering the number of pieces of content used and the royalty token in the blockchain.

It should be noted that any combination of the above-described constituent elements, and an aspect obtained by converting the expression of the present invention among methods, devices, systems, computer programs, data structures, recording media, and the like are also effective as an aspect of the present invention.

### BRIEF DESCRIPTION OF THE DRAWINGS

FIG. 1 is a schematic diagram illustrating an overview of a license fee management system according to an embodiment.

FIG. 2 schematically shows a functional configuration of an information processing apparatus according to the embodiment.

FIG. 3 schematically shows a configuration of a blockchain according to the embodiment.

FIG. 4 schematically shows contents of an automatic remittance request history stored in the blockchain according to the embodiment.

FIG. 5 is a table showing details of per-unit license fees stored in the blockchain according to the embodiment.

FIG. 6 is a flowchart for illustrating information a process flow performed by the information processing apparatus according to the embodiment.

FIGS. 7A and 7B are diagrams schematically showing contents of automatic remittance request history stored in the blockchain according to a variation of the embodiment.

FIGS. 8A and 8B are tables showing details of the per-unit license fees stored in the blockchain according to a variation of the embodiment.

### DETAILED DESCRIPTION OF THE INVENTION

### Background of the Embodiment

Prior to the description of a license fee management system according to the embodiment, the current situation will be described in the background.

A business model exists in which a creator who created or devised new content licenses a right to use the content to others and receives a license fee on the basis of the number of products manufactured or sold using the content. Specifically, it is a business model in which, when the right can be granted to another company on the basis of a copyright, a patent right, a trademark right, a design right, a publicity right, and the like related to the content, which is a product created by the creator, a right to use the above right is licensed to another company to obtain a profit.

For example, when the creator has created a character as content, he/she may allow others to manufacture and sell products such as stationery and tableware on which the character is attached and games and movies featuring the character, or may use a distribution server to distribute digital content such as videos and still images in which the character appears. Alternatively, when a creator devises a technique relating to a method of manufacturing an object, he/she may license that technique to other companies for use.

Hereinafter, in this disclosure, a person who grants the right to use the content to another person is referred to as a “licensor,” and a person who receives the right to use the content from another person is referred to as a “licensee.” In many cases, a creator of content is a licensor, but it is not limited thereto. For example, when a person requests another person to create content, the person who requests the creation of the content, not the creator of the content, may be the licensor.

These license fees are generally determined on the basis of the number of products using the content that have been manufactured or sold, the number of pieces of digital content distributed, and the like (hereinafter referred to as “number of uses” in this disclosure). The licensor calculates the license fee on the basis of the number of uses reported by the licensee. It should be noted that the license fee is calculated on the basis of sales that depend on the number of uses and a unit price of the product in some cases, but the license fee is calculated on the basis of the number of uses in any case.

There is no mechanism here to have the licensee accurately report the number of uses to the licensor, and there is a risk that the licensee may report a lower number of uses than the actual number of uses or false sales, to the licensor. For this reason, it is common for licensors to request a minimum guarantee from licensees when providing licenses to the licensees, but this is a burden for the licensees because they need a large sum of money before they sell their products. In particular, those with limited financial resources are unable to become licensees due to their inability to pay the minimum guarantee.

### Outline of Embodiment

A license fee management system according to the embodiment uses blockchain technology to ensure transparency of the number of products used, as a basis for calculating the license fee. Blockchain can be regarded as a type of distributed database technology in which all participants share a huge ledger that records a history of all participants' transactions. Therefore, the licensor, the licensee, and an execution management system for managing execution of matters (for example, manufacture and sale of products, distribution of digital content, and the like) stipulated by a contract participate in the same blockchain, and the number of uses is registered in the blockchain, whereby the licensor and the licensee can share the number of uses.

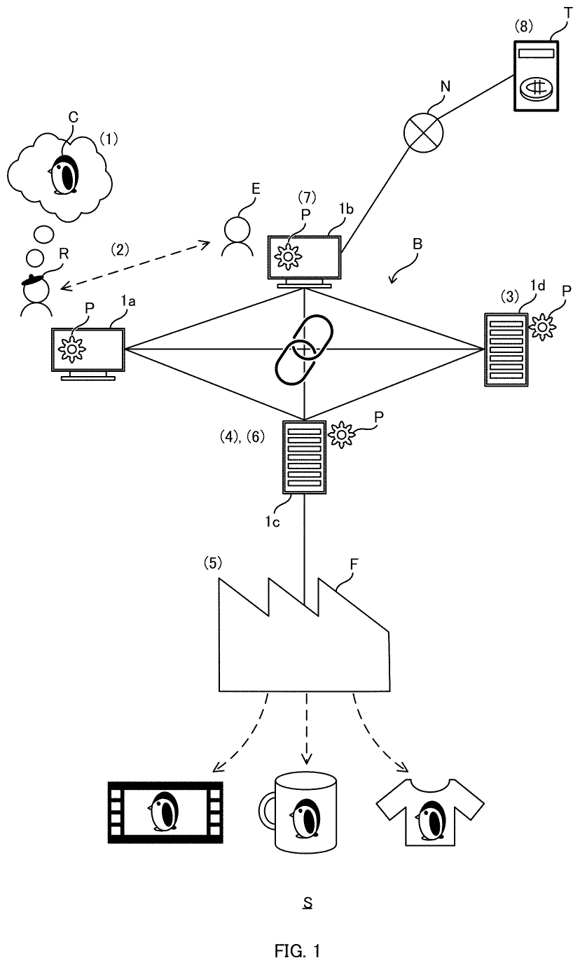

FIG. 1 is a schematic diagram illustrating an overview of a license fee management system S according to an embodiment. The license fee management system S according to the embodiment includes a licensor terminal 1a used by a licensor R, a licensee terminal 1b used by a licensee E, an execution management system 1c for managing execution of matters by the licensee E, with the matters being stipulated in a contract, a license agreement system 1d for creating a blockchain B in which a contract function is implemented to realize a license agreement for the use of content C agreed upon between the licensor R and the licensee E, and a license fee remittance system T used by the licensee E. In the license fee management system S, the licensor terminal 1a, the licensee terminal 1b, the execution management system 1c, and the license agreement system 1d share the same blockchain B.

The blockchain B is a blockchain that implements the contract function, and is realized in Ethereum, for example. A contract is a process executed at the time of a transaction, and is implemented by a contract program P written using a prescribed programming language. The contract program P is executed at the licensor terminal 1a, the licensee terminal 1b, the execution management system 1c, and the license agreement system 1d, which participate in the blockchain B thereby recording the number of uses in the blockchain B indicating the number of matters, stipulated in the contract, that have been performed by the licensee.

The following is a description of an outline of a process according to the embodiment in the order of (1) to (8) with reference to FIG. 1, which corresponds to (1) through (8) in FIG. 1. It should be noted that, for convenience of description, FIG. 1 assumes that the creator of the content C and the licensor R are the same. Further, it is also assumed that the licensee E manufactures and sells a tangible object using the content C. However, as will be described below, the product handled by the licensee E may be an intangible object such as digital content.

(1) The licensor R creates new content C. In an example shown in FIG. 1, the licensor R creates a penguin character.

(2) A contract is concluded between the licensor R and the licensee E to the effect that the licensee E is permitted to use the content C created by the licensor R and that the licensee E pays the licensor R compensation on the basis of the number of uses of such content C.

(3) The license agreement system 1d adds a new license agreement to the blockchain B for storing contract content in order to realize the license agreement for the use of the content C agreed upon between the licensor R and the licensee E. Further, the blockchain B is implemented with the contract program P that allows a computer to realize the contract function to realize the license agreement.

Once the license agreement system 1d registers the contract content in the blockchain B, no one can change the contract content. This is because even if the contract content stored in a certain blockchain B is tampered with in some way, the tampering is rejected by a consensus algorithm included in the blockchain B. It should be noted that the blockchain B created by the license agreement system 1d will be described in detail later.

(4) The licensee E forms a contract with an administrator of the execution management system 1c to have the execution management system 1c perform management of the number of uses of the content C (that is, management of i) the number of products using the content C manufactured and sold and ii) sales).

(5) The licensee E manufactures the products using the content C at a production plant F and sells them, under the control of the execution management system 1c. FIG. 1 shows an example in which the licensee E manufactures and sells a moving image in which the content C appears, and mugs and T-shirts with the content C printed on them. As described above, if the contract between the licensee E and the licensor R is a manufacturing and sales agreement for the products using the content C, the execution management system 1c functions as a known Supply Chain Management system (SCM system).

(6) The execution management system 1c registers the number of uses, including the number of products manufactured at the production plant F and sold on the market, in the blockchain B. This means that the licensor terminal 1a and the licensee terminal 1b, which participate in the blockchain B, can also refer to the number of uses registered in the blockchain B at any time, and the accuracy of the information is ensured by the consensus algorithm included in the blockchain B.

(7) When the number of uses, including the number of products manufactured at the production plant F and sold on the market, is newly registered in the blockchain B, the licensee terminal 1b instructs the license fee remittance system T to pay the license fee on the basis of the contract content stored in the blockchain B. In the example shown in FIG. 1, the license fee remittance system T is a bank. In this case, the bank, which is the license fee remittance system T, does not participate in the blockchain B, but is connected to the licensee terminal 1b via the communication network N. It should be noted that, if a cryptographic asset (token) is used to pay the license fee, the license fee remittance system T may be a cryptographic asset exchange operated by a cryptographic asset exchanger. In this case, the license fee remittance system T may participate in the blockchain B.

(8) The license fee remittance system T transfers a royalty equivalent to the license fee from an account of the licensee E to an account of the licensor R, on the basis of the instruction to pay the license fee.

As described above, in the license fee management system S according to the embodiment, the number of uses (for example, the number of products using the content C manufactured or sold), which is information serving as a basis for payment of the license fee, is registered in the blockchain B in which the licensor terminal 1a and the licensee terminal 1b participate. This allows the license fee management system S to increase the transparency of the number of pieces of content C used under the license. Further, the blockchain B according to the embodiment allows the licensee E to automatically pay the license fee to the licensor R by using a smart contract functionality.

### <Functional Configuration of Information Processing Apparatus 1 According to the Embodiment>

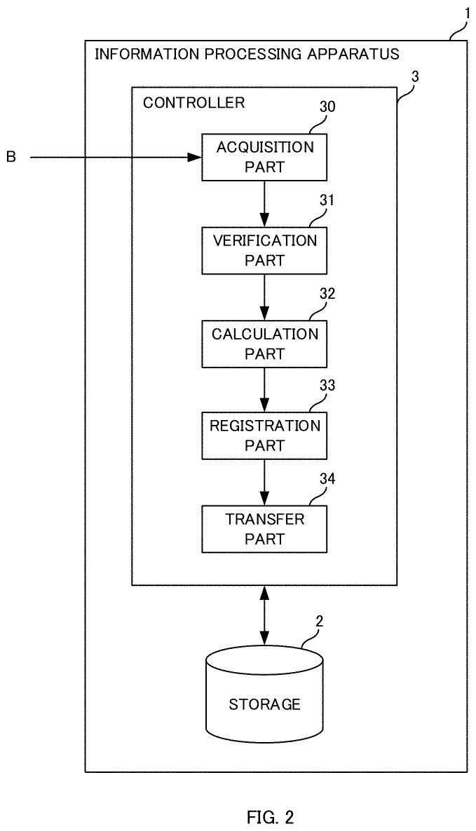

FIG. 2 schematically shows a functional configuration of the information processing apparatus 1 according to the embodiment. The information processing apparatus 1 is a computer for realizing the function of the license fee payment contract implemented in the blockchain B in which the contract function is implemented, and specifically, is the licensor terminal 1a, the licensee terminal 1b, the execution management system 1c, and the license agreement system 1d. The information processing apparatuses 1 respectively include a storage 2 and a controller 3.

In FIG. 2, arrows indicate main data flow, and there may be data flows not shown in FIG. 2. In FIG. 2, each functional block is not a hardware (device) unit configuration, but a functional unit configuration. Therefore, the functional blocks shown in FIG. 2 may be implemented in a single device, or may be implemented separately in a plurality of devices. Data may be exchanged between functional blocks via any means, such as a data bus, network, or portable storage medium.

The storage 2 is a mass storage device such as a Hard Disk Drive (HDD) or a Solid State Drive (SSD) that stores a Read Only Memory (ROM) storing a Basic Input Output System (BIOS) and the like of a computer that realizes the information processing apparatus 1, a Random Access Memory (RAM) that serves as a work area of the information processing apparatus 1, an Operating System (OS), the contract program P to realize the contract function implemented in the blockchain B, and various pieces of information referenced when executing said contract program P.

The controller 3 is a processor such as a Central Processing Unit (CPU) or a Graphics Processing Unit (GPU) of the information processing apparatus 1, and functions as an acquisition part 30, a verification part 31, a calculation part 32, a registration part 33, and a transfer part 34 by executing the program stored in the storage 2.

The acquisition part 30 acquires a per-unit license fee for use of the content C from the blockchain B. In addition, the acquisition part 30 acquires a public key issued by the execution management system 1c used by the licensee E from the blockchain B.

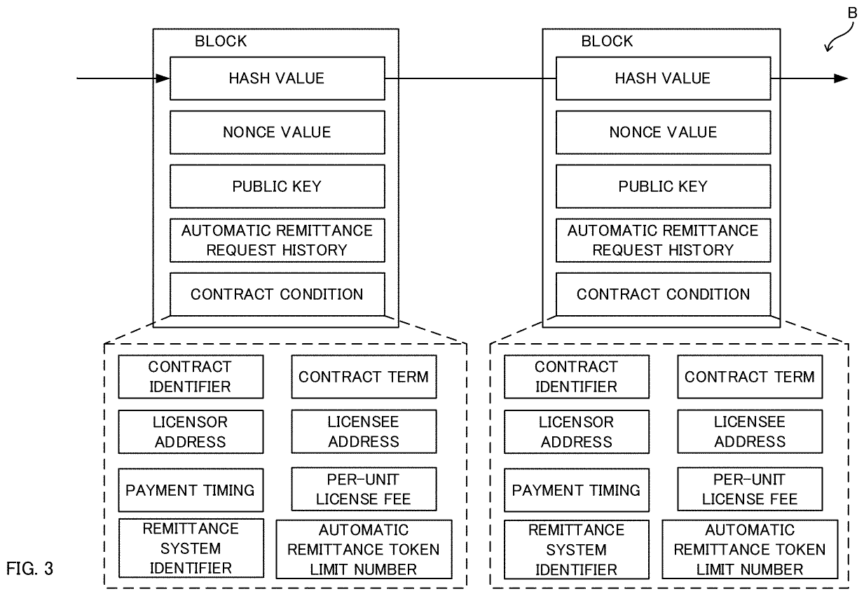

FIG. 3 schematically shows a configuration of the blockchain B according to the embodiment. As shown in FIG. 3, the blockchain B is information consisting of a plurality of blocks linked together. Each of the plurality of blocks contain (i) a hash value of information indicating the immediately preceding block, (ii) a nonce value, (iii) a public key, (iv) an automatic remittance request history recording a request for automatic remittance by the license fee remittance system T, and (v) a contract condition indicating the content of the contract concluded between the licensor R and the licensee E.

Here, the “nonce value” contained in the blockchain B is information used to make the hash value of the block satisfy a specific condition. Further, the “public key” is a public key issued by the execution management system 1c used by the licensee E. The “automatic remittance request history” is information storing a history of payment of the license fee by the license fee remittance system T.

The “contract condition” contained in the blockchain B contains contents agreed upon between the licensor R and the licensee E concerning the use of the content C. Specifically, as shown in FIG. 3, the contract condition contains a contract identifier, a contract term, a licensor address, a licensee address, a payment timing, a per-unit license fee, a remittance system identifier, and an automatic remittance token limit number.

The contract identifier is an identifier assigned by the license agreement system 1d for each contract managed by the blockchain B. The license agreement system 1d assigns different contract identifiers to different contracts, even if the contractor is the same party.

The contract term is information indicating a validity period of the contract identified by the contract identifier, and includes a start date of the contract and an end date of the contract. The licensor address is information for identifying the account of the licensor R. Further, the licensee address is information for identifying the account of the licensee E. These accounts may be token accounts for managing the cryptographic assets. The following description assumes that both the licensor R's account and the licensee E's account are token accounts.

The token account is an electronic account for each of the licensor R and licensee E that is used to transfer the license fee. The licensor address is information linking to the licensor's token account opened on a token management server (not shown in figures) that exists outside of the information processing apparatus 1 to manage a token payment. Similarly, the licensee address is information linking to the licensee's token account opened on the token management server. The token management server can only be accessed via the link information stored in the blockchain B. It should be noted that the license fee remittance system T may also serve as the token management server.

The payment timing is information indicating when the licensee E pays the license fee to the licensor R. Details of the payment timing will be described later, but the licensee E pays the license fee to the licensor R at the stage when the manufacture of the product using content C is completed, for example. In this case, the payment timing is at the stage of completion of the product manufacturing. In addition to this, the payment timing may include test manufacturing, test sales, and planning-stage-manufacturing prior to the start of full-scale manufacturing and sales.

The per-unit license fee is a unit for calculating the license fee. The per-unit license fee is the license fee per product using the content C, for example. Alternatively, when the licensee E has obtained a license for a character that is the content C from the licensor R and distributes an advertising moving image in which the character appears on a video provision server, the license fee is per number of views (so-called “number of page views (PV)”) of the advertising moving image. It should be noted that, when a plurality of payment timings exist, the per-unit license fee for each payment timing is defined.

The remittance system identifier is information for identifying the license fee remittance system T. The automatic remittance token limit number is information that defines an upper limit of the token to be transferred per unit period that the license fee remittance system T is allowed to automatically remit from the licensee E's token account to the licensor R's token account.

Thus, the acquisition part 30 can acquire the per-unit license fee and the public key by referring to the blockchain B.

Subsequently, the acquisition part 30 acquires content usage information from the execution management system 1c. Here, the content usage information is information that includes the number of uses of the content C by the licensee E, and is information signed using the private key corresponding to the public key.

The verification part 31 uses the public key to verify the validity of a signature of the content usage information. This allows the verification part 31 to verify that the acquired content usage information is information generated by the execution management system 1c. Since an apparatus other than the execution management system 1c cannot affix a valid signature even if the apparatus falsifies the content usage information, the verification part 31 can detect and discard improperly generated content usage information.

Under the condition that the signature is valid, the calculation part 32 calculates a royalty token corresponding to an amount obtained by multiplying the number of uses of the content C by the per-unit license fee. The registration part 33 registers the number of uses of the content C and the royalty token in the blockchain B. This allows the number of uses of the content C and the royalty token to be referenced at any time from the licensor terminal 1a and the licensee terminal 1b, which are devices participating in the blockchain B. Further, since the number of uses of the content C used, which is the basis for calculating the royalty token, is stored in the contents usage information signed by the execution management system 1c used by the licensee E, the validity thereof is guaranteed. As described above, the blockchain B in which the license fee payment contract function is implemented manages the number of uses of the content C, such that the information processing apparatus 1 can enhance the transparency of the number of products manufactured or sold, or sales under the license.

Here, the content usage information acquired by the acquisition part 30 from the execution management system 1c includes a remittance system identifier for identifying the license fee remittance system T used by the licensee E. The remittance system identifier is information for identifying the license fee remittance system T. The remittance system identifier is assigned for each of several different license fee remittance systems T.

On condition that the signature affixed to the content usage information is valid, the transfer part 34 causes the license fee remittance system T identified by the remittance system identifier to transfer the royalty token from the token account identified by the licensee address to the token account identified by the licensor address. Thus, the information processing apparatus 1 can identify the license fee remittance system T that is to execute the payment of the license fee by referring to the remittance system identifier, thereby realizing automation of license fee payments by paying the license fee in the identified license fee remittance system T.

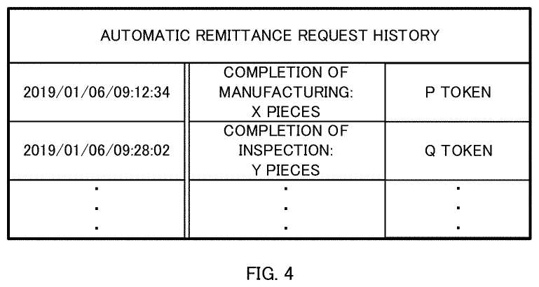

FIG. 4 schematically shows contents of the automatic remittance request history stored in the blockchain B according to the embodiment. As mentioned above, the timing of the license fee payment by the licensee E to the licensor R is defined in advance by the contract and is stored in the blockchain B. In the example shown in FIG. 4, the payment timing includes at least a manufacturing completion stage and an inspection completion stage of the product using the content C. In FIG. 4, it is recorded that manufacturing of X pieces of product was completed at 9:12:34 AM Jan. 6, 2019, and a payment of the license fee for a P token occurred. Similarly, it indicates that inspection of Y pieces of product was completed at 9:28:02 AM on the same day and a payment for a Q token occurred.

Since the automatic remittance request history is stored in the blockchain B, the history can be referenced by the licensor terminal 1a and the licensee terminal 1b, which are devices participating in the blockchain B, at any time. This allows the licensor R and the licensee E to check an accurate payment status of the license fee at any time without making an inquiry to each other.

Here, as mentioned above, the contract condition registered in the blockchain B also includes the remittance system identifier. Therefore, the acquisition part 30 may also acquire the remittance system identifier from the blockchain B. In this case, the transfer part 34 may transfer the royalty token on condition that the signature affixed to the content usage information is valid and the remittance system identifier acquired from the blockchain B matches the remittance system identifier contained in the content usage information. Thus, the transfer part 34 can pay the license fee by using only the license fee remittance system T determined in advance by the contract between the licensor R and the licensee E.

If the payment of the license fee is automated by the license fee remittance system T, there may be a situation where an excessive payment of the license fee occurs for some reason, such as a bug in the program. Therefore, the acquisition part 30 acquires, from the blockchain B, the automatic remittance token limit number that defines the upper limit of the royalty token to be transferred per unit period from the token account identified by the licensee address to the token account identified by the licensor address. The unit period may be arbitrarily determined by contract between the licensor R and the licensee E, and is one hour, one day, one month, or the like, for example.

The transfer part 34 transfers the royalty token on condition that the royalty token to be transferred is within a range of the automatic remittance token limit number. This allows the transfer part 34 to suppress the situation where excessive license fees are paid for some reason.

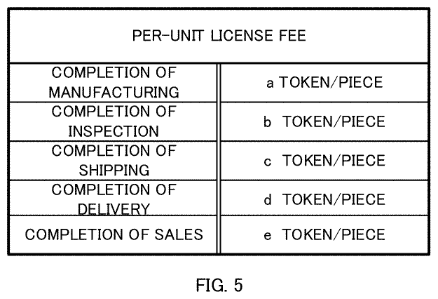

FIG. 5 is a table showing details of the per-unit license fees stored in the blockchain B according to the embodiment. As shown in FIG. 5, the per-unit license fee for use of the content is determined for each phase of use of the content C by the licensee E.

Specifically, the content use phase includes completion of at least one of the following phases: manufacture of the product related to the content C, inspection of the product, shipment of the product, delivery of the product, or sale of the product. In the example shown in FIG. 5, “a” token occurs per product when the manufacturing of the product related to the content C is completed. In addition, “b” token occurs per product when the inspection of the product related to the content C is completed. The same applies for phases listed below.

It is not illustrated in FIG. 5, but the per-unit license fee may be a different fee depending on a style guide determined at the time of entering the contract. Here, the “style guide” is a regulation that defines a design or the like when manufacturing or producing products, digital content, and the like that use the content C. The per-unit license fee may be determined for each style.

Thus, by using the contract function implemented in the blockchain B to realize the license agreement, the payment of license fees can be finely set according to the phase of use of the content C by the licensee E. Thus, for example, a license fee that occurs in a lump sum at the completion of manufacture of the product (that is, the first stage in FIG. 5) or at the completion of sales of the product (that is, the final stage in FIG. 5) can be split according to the phase of use of the content C. If the license fee occurs at the phase of completion of manufacturing the product, the licensee E needs to pay the license fee to the licensor R even if the product cannot be sold, which is a risk. On the other hand, if the license fee occurs at the phase of selling the product, the licensor R will not receive the license fee unless the product is sold, which is a risk. These risks can be reduced by splitting the license fee into phases of use of the content C.

### <Process Flow of Information Processing Method Executed by Information Processing Apparatus 1>

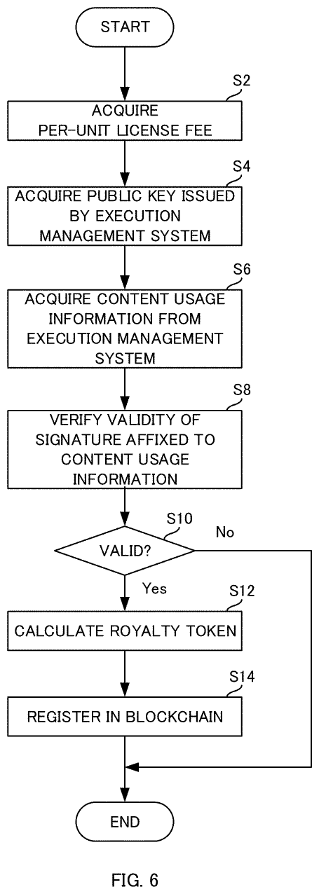

FIG. 6 is a flowchart for illustrating information a process flow performed by the information processing apparatus 1 according to the embodiment. Each process in this flowchart is executed in a distributed manner in each information processing apparatus 1 that executes the function of the license fee payment contract implemented in the blockchain B in which the contract function is implemented. Therefore, the processing in this flowchart executed by each information processing apparatus 1 starts when the information processing apparatus 1 is activated.

The acquisition part 30 acquires the per-unit license fee for use of the content C from the blockchain B in which the contract function for realizing the license agreement related to use of the content C agreed upon between the licensor R and the licensee E is implemented (step S2).

The acquisition part 30 acquires the public key issued by the execution management system 1c used by the licensee E, from the blockchain B (step S4). The acquisition part 30 acquires, from the execution management system 1c, the content usage information, which is the information including the number of pieces of content C used by the licensee E and which is the information signed using the private key corresponding to the public key (step S6).

The verification part 31 verifies the validity of the signature affixed to the content usage information using the public key (step S8). If the signature is valid (Yes in step S10), the calculation part 32 calculates the royalty token corresponding to an amount obtained by multiplying the number of pieces of content C used by the per-unit license fee (step S12).

The registration part 33 registers the number of pieces of content C used and the royalty token in the blockchain B (step S14). If the registration part 33 registers the number of pieces of content C used and the royalty token in the blockchain B, or if the signature of the content usage information is not valid (No in step S10), the process in this flowchart ends.

### <Effect of Information Processing Apparatus 1 According to the Embodiment>

As described above, according to the information processing apparatus 1 of the embodiment, it is possible to enhance transparency of the number of products manufactured and sold, and sales of the products manufactured under the license.

The present invention is explained on the basis of the exemplary embodiments. The technical scope of the present invention is not limited to the scope explained in the above embodiments and it is possible to make various changes and modifications within the scope of the invention. For example, all or part of the apparatus can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

### <Variation>

In the above, the case where the licensee E manufactures and sells the product using the content C licensed by the licensor R has mainly been described, but the product handled by the licensee E is not limited to a tangible product, and may be an intangible product such as digital content. The following is a description of the case where the product handled by the licensee E is digital content, and descriptions that overlap with those mentioned above will be omitted or simplified as appropriate.

The digital content according to the variation is a generic term for electronic information that can be played using a computer or smartphone. Examples of the digital content include digital moving images, digital still images, electronic books, music, and the like. The digital moving images include movies, dramas, animations, news, advertisements, and the like. The following description assumes that the product handled by the licensee E is a digital moving image. In this case, the execution management system 1c in FIG. 1 functions as a system for managing moving image distribution, and the production plant F is replaced by a moving image distribution server.

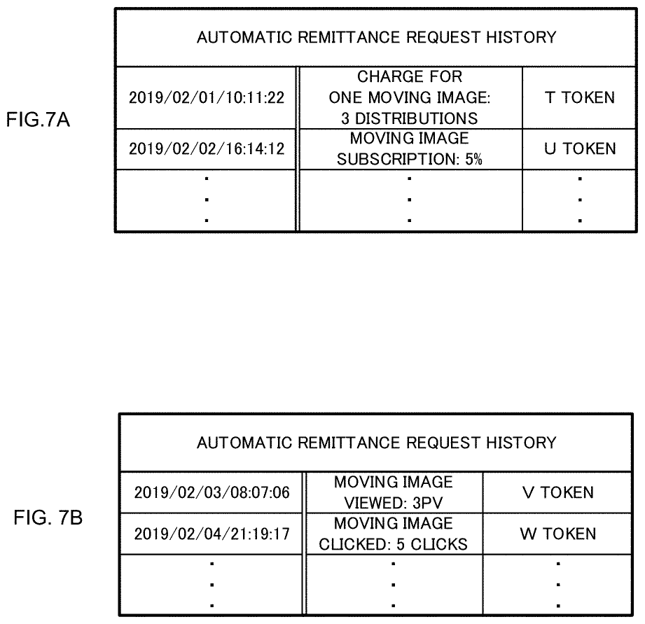

FIGS. 7A and 7B are diagrams schematically showing contents of the automatic remittance request history stored in the blockchain B according to the variation of the embodiment. Specifically, FIG. 7A is a diagram showing the contents of the automatic remittance request history in a case where a moving image, in which the content C such as a character licensed by the licensor R and handled by the licensee E appears, is produced and distributed on the Web by the licensee E. Further, FIG. 7B is a diagram showing the contents of the automatic remittance request history in a case where an advertising moving image, in which the content C such as a character licensed by the licensor R appears, is produced and distributed on the Web by the licensee E.

As shown in FIG. 7A, when only the moving image produced by the licensee E is distributed, the license fee is charged in accordance with the number of distributions. Further, when the moving image produced by the licensee E is distributed together with other moving images through a subscription contract, the license fee is charged in accordance with a ratio of a distribution amount of a target moving image to an overall distribution amount in a predetermined period (for example, one year or one month).

In addition, as shown in FIG. 7B, in a case where the advertising moving image, in which the content C such as a character licensed by the licensor R appears, is produced and distributed on the web by the licensee E, the license fee is charged in accordance with the number of views and clicks of the moving image distributing the advertisement in a predetermined period (for example, one year or one month).

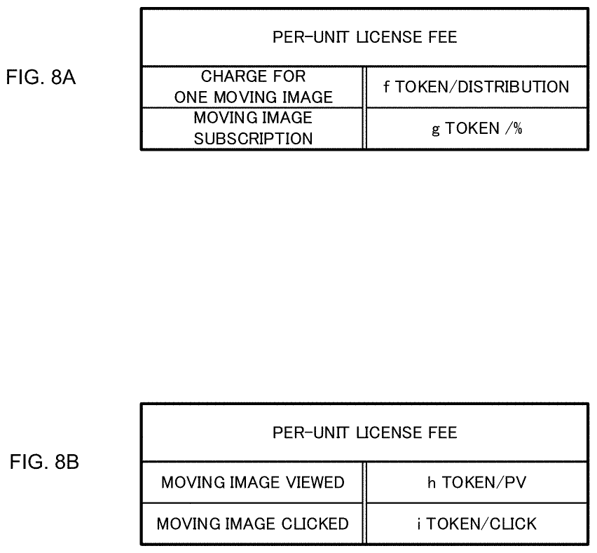

FIGS. 8A and 8B are tables showing details of the per-unit license fees stored in the blockchain B according to the variation of the embodiment. More specifically, FIG. 8A is a diagram showing the license fee in the case where the moving image, in which content C such as a character licensed by the licensor R appears, is handled, produced, and distributed on the Web by the licensee E. Further, FIG. 8B is a diagram showing the license fee in the case where an advertising moving image, in which the content C, such as a character licensed by the licensor R appears, is produced and distributed on the Web, by the licensee E.

As shown in FIG. 8A, when only the moving image produced by the licensee E is distributed, the license fee per distribution is set. In the example shown in FIG. 8A, the license fee of “f” token is set per distribution. Therefore, the value obtained by multiplying the “f” token by the actual distribution number is the license fee to be paid by the licensee E to the licensor R.

In addition, when the moving image produced by the licensee E is distributed together with other moving images through a subscription contract, the license fee is set per 1% on the basis of the ratio of the amount of the target moving image distributed to the overall distribution amount as a unit. In the example shown in FIG. 8A, the license fee of “g” token per 1% is set. Therefore, the value obtained by multiplying the “g” token by the ratio of the actual distribution number is the license fee to be paid by the licensee E to the licensor R.

Further, as shown in FIG. 8B, when the advertisement moving image, in which the content C such as a character licensed by the licensor R appears, is produced and distributed on the Web by the licensee E, the license fee per PV or the license fee per click of the moving image distributing the advertisement is set. In the example shown in FIG. 8B, the license fee of “h” token per PV is set. Therefore, the value obtained by multiplying the “h” token by the number of PVs is the license fee to be paid by the licensee E to the licensor R. When the license fee is determined in accordance with the number of clicks, the value obtained by multiplying “i” token, which is the license fee per click, by the actual number of clicks is the license fee to be paid by the licensee E to the licensor R.

As described above, a subject to which the licensor sets the license for the licensee E is not limited to a tangible object, and the present disclosure is applicable to an intangible object such as digital content or an intellectual property right.

What is claimed is:

1. An information processing method comprising the steps, executed by a processor of a computer executing a license fee payment contract function implemented in a blockchain in which a contract function is implemented to realize a license agreement for use of content agreed upon between a licensor and a licensee, of:
acquiring a per-unit license fee for use of the content from the blockchain;
acquiring a public key issued by an execution management system used by the licensee, from the blockchain;
acquiring content usage information that is information including a number of pieces of content used by the licensee and that is information signed using a private key corresponding to the public key, from the execution management system;
verifying validity of a signature of the content usage information using the public key;
calculating a royalty token corresponding to an amount obtained by multiplying the number of pieces of content used by the per-unit license fee, on condition that the signature is valid; and
registering the number of pieces of content used and the royalty token in the blockchain.

2. The information processing method according to claim 1, wherein
the content usage information includes a remittance system identifier for identifying a license fee remittance system used by the licensee, and
the information processing method further comprises the steps of:
acquiring a licensor address for identifying a token account of the licensor and a licensee address for identifying a token account of the licensee, from the blockchain; and
causing the license fee remittance system identified by the remittance system identifier to transfer the royalty token from the token account identified by the licensee address to the token account identified by the licensor address, on condition that the signature is valid.

3. The information processing method according to claim 2, further comprising the step of:
acquiring a remittance system identifier for identifying a license fee remittance system used by the licensee, from the blockchain, wherein
the royalty token is transferred in the transferring, on condition that the signature is valid and the remittance system identifier acquired from the blockchain matches the remittance system identifier included in the content usage information.

4. The information processing method according to claim 2, further comprising the step of:
acquiring an automatic remittance token limit number that defines an upper limit of the royalty token to be transferred per unit time from the token account identified by the licensee address to the token account identified by the licensor address, from the blockchain, wherein
the royalty token is transferred in the transferring, on condition that the royalty token to be transferred is within a range of the automatic remittance token limit number.

5. The information processing method according to claim 1, wherein
the per-unit license fee for use of the content is determined for each phase of use of the content by the licensee.

6. The information processing method according to claim 5, wherein
the phase of use of the content includes completion of at least one of: manufacture of a product related to the content, inspection of the product, shipment of the product, delivery of the product, or sale of the product.

7. A non-transitory computer-readable storage medium storing a program for causing a computer to realize:
a license fee payment contract function implemented in a blockchain in which a contract function is implemented to realize a license agreement for use of a content agreed upon between a licensor and a licensee; wherein
the license fee payment contract function includes:
acquiring a per-unit license fee for use of the content from the blockchain,
acquiring a public key issued by an execution management system used by the licensor, from the blockchain,
acquiring content usage information that is information including a number of pieces of content used by the licensee and that is information signed using a private key corresponding to the public key, from the execution management system,
verifying validity of a signature of the content usage information using the public key,
calculating a royalty token corresponding to an amount obtained by multiplying the number of pieces of content used by the per-unit license fee on condition that the signature is valid, and
registering the number of pieces of content used and the royalty token in the blockchain.
